(19) United States
(12) Patent Application Publication
(10) Pub. No.: US 2005/0010539 A1
(43) Pub. Date: Jan. 13, 2005

(54) Marine product configuration and pricing system having a variable price component

(76) Inventors: Mark Zwicker, Mountain Home, AR (US); Matthew Zwicker, Mountain Home, AR (US)

Correspondence Address: MERCHANT & GOULD PC, P.O. BOX 2903, MINNEAPOLIS, MN, 55402-0903, US

(21) Appl. No.: 10/696,298

(22) Filed: Oct. 28, 2003

Related U.S. Application Data
(60) Provisional application No. 60/486,265, filed on Jul. 10, 2003.

(51) Int. Cl. G06F 17/60

(52) U.S. Cl. 705/400; 705/1

(57) ABSTRACT

A method, apparatus and article of manufacture for a marine product configuration and pricing system is disclosed. The invention provides an index product module for displaying all available products that may be configured, and a markup module for specifying the amount a dealer price may be changed for a product and optional items. The invention also provides a price quoting generation module for selecting the product and optional items to be included within a configured product and for generating a customer price, and a quote sheet module for generating a quote sheet document containing information describing the configured product and its generated price.

### RELATED APPLICATIONS

This application claims priority from U.S. Provisional Application Ser. No. 60/486,265, filed Jul. 10, 2003.

### TECHNICAL FIELD

This application relates in general to a method, apparatus, and article of manufacture for assisting sales of products, and more particularly to a method, apparatus, and article of manufacture for providing a marine product configuration and pricing system.

### BACKGROUND

Configuration and pricing systems have become automated through the use of computer based processing systems to ease the creation of customized products. Similarly, these systems may assist in the pricing of these products as the products are configured. These systems typically use a manufacturers suggested set of prices for optional items that may result in a single discount to be applied to a configured product to determine a price quote that is given to a customer.

Because a seller or dealer may obtain the set of optional items to be included and installed in a configured product from different sources, the items may have different prices. The ability to generate a price that is based upon the differing set of prices for these options as the product is configured is lacking in prior art systems. In addition, most prior art systems do not readily display the customer and dealer cost for all selected items as part of the configuration process. The display of the two sets of prices and the ability to modify the markup available for individual options or groupings of options separate from other options would assist in the easy configuration and pricing of custom products.

As discussed above, there is a further need for providing a marine product configuration and pricing system having a variable price component. These and numerous other disadvantages of the prior art necessitates the need for the method and apparatus provided by the present invention.

### SUMMARY

This application relates in general to a method, apparatus, and article of manufacture for providing a marine product configuration and pricing system. One possible embodiment of the present invention is to a system for providing a marine product configuration and pricing system. The system includes an index product module for displaying all of the available products that may be configured; a markup module for specifying the amount a dealer price may be increased for a product and optional item based upon a specified figure; a price quoting generation module for selecting the product and optional items to be included within a configured product, the price quoting generation module generates a customer price for the product, selected optional items, and a total price for the configured product using the pricing data from the markup module; and a quote sheet module for generating a quote sheet document containing information describing the configured product and its generated price.

Another aspect of the present invention is a method and corresponding computer data product for providing a marine product configuration and pricing system. The method selects a configurable product from a group of available products; selects one or more optional items from a group of available optional items corresponding to the selected configurable product; generates a dealer cost for the selected configurable product and the selected one or more optional items from a database of dealer costs; generates a customer price for the selected configurable product and the selected one or more optional items using the dealer costs and a price increase value corresponding to the selected configurable product and to each of the selected one or more selected optional items; and generates an individualized price quote document for the selected configurable product and the selected one or more optional items.

### BRIEF DESCRIPTION OF THE DRAWINGS

FIG. 1 illustrates an example embodiment of a system for providing a marine product configuration and pricing system according to one possible embodiment of the present invention.

FIG. 2 illustrates a computing system that may be used to construct a marine product configuration and pricing system according to one possible embodiment of the present invention.

FIG. 3 illustrates a marine product configuration and pricing system for a plurality of boat and supported options according to one possible embodiment of the present invention.

FIG. 4 illustrates an example price quote constructed using a marine product configuration and pricing system according to one possible embodiment of the present invention.

FIG. 5 illustrates an example a marine product configuration and pricing system having variable price markups for options according to one possible embodiment of the present invention.

FIG. 6 illustrates an example customer pricing quote for a marine product configuration and pricing system according to one possible embodiment of the present invention.

FIG. 7 illustrates another example of a marine product configuration and pricing system used to generate a price quote according to one possible embodiment of the present invention.

FIG. 8 illustrates an example of a pricing and configuration input screen for an example product according to one possible embodiment of the present invention.

FIG. 9 illustrates another example of a pricing and configuration input screen for an example product according to one possible embodiment of the present invention.

FIG. 10 illustrates an example screen for selection of a price quote of a custom configured product according to one possible embodiment of the present invention.

FIG. 11 illustrates another example screen for selection of a price quote of a custom configured product according to one possible embodiment of the present invention.

FIG. 12 illustrates an example screen for copying and pasting of a selection of a price quote of a custom configured product according to one possible embodiment of the present invention.

FIG. 13 illustrates an example customer list generated within a marine product configuration and pricing system according to one possible embodiment of the present invention.

FIG. 14 illustrates an example dealer sales management sheet generated within a marine product configuration and pricing system according to one possible embodiment of the present invention.

### DETAILED DESCRIPTION

This application relates in general to a method, apparatus, and article of manufacture for providing a marine product configuration and pricing system. In the following detailed description of exemplary embodiments of the invention, reference is made to the accompanied drawings, which form a part hereof, and which is shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined only by the appended claims.

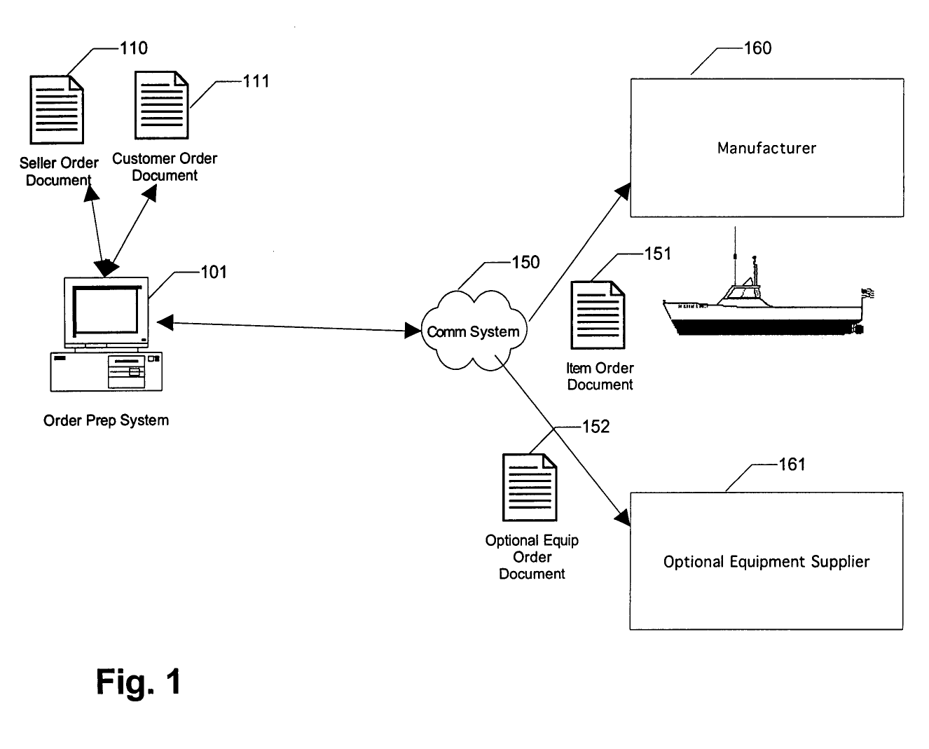

FIG. 1 illustrates an example embodiment of a system for providing a marine product configuration and pricing system according to one possible embodiment of the present invention. The system comprises a marine product configuration and pricing system 101 that is used by a sales person to prepare a configured product for a particular customer. The marine product configuration and pricing system 101, as discussed in more detail below, permits a sales person to add any number of optional items to the custom configured product. These additional items are based upon a set of optional items that are known to be available for the particular product being configured.

In preparing the order documentation, the marine product configuration and pricing system 101 will determine the price for the uniquely configured product. The system 101 calculates both a dealer price and a customer price or the product and all of the selected optional items added in the configuration process. The dealer price is obtained from a database of product and optional item costs that are included within the marine product configuration and pricing system 101. The customer price, as described in more detail below, will be calculated based upon the dealer costs and an additional markup or price margin that is used to permit the dealer to make a profit.

Once the system 101 accepts the inputs from the sales person and customer to specify the custom configured product and its corresponding optional items, the system 101 generates both customer order documentation 111 and dealer order documentation 110 that identifies the product, the included optional items selected, and the appropriate pricing figure. In this process, the customer is generally not permitted to view the dealer's cost unless the dealer expressly chooses to share the pricing with the customer.

When the dealer and customer agree to complete the transaction, the system 101 may also generate product ordering information and related documentation 151 that may be communicated to a product manufacturer 160 to generate the product to be sold. Similar optional equipment order documentation 152 may be generated for each of the optional items to be included in the custom product as configured. In cases where optional items are acquired from a single reseller 161, a single optional equipment order document 152 may be generated for all of the optional items purchased from a particular reseller 161. The manufacturer 160 and optional equipment reseller 161 may complete the respective orders and ship their items to the dealer. The dealer completes the assembly of the custom product as required and sells the complete product to the customer.

The various order documents 151-152 are shown being communicated by the marine product configuration and pricing system 101 over a communications network 150 to the manufacturer 160 and resellers 161. One skilled in the art will recognize that these documents may be communicated using a facsimile machine, a computer modem and other similar communications mechanisms for transmitting the order information from a dealer to the manufacturer without deviating from the spirit and scope of the present invention as recited within the attached claims.

In some cases, the product itself and some or all of the optional items may be in stock of the dealer of the product rather than be ordered from another party. In these circumstances, the item order documents 151 and optional equipment order documents 152 may not be needed, or may be replaced with documentation to obtain these items from the stock of the dealer. One skilled in the art will recognize numerous other configurations of such a system without deviating from the spirit and scope of the present invention as recited within the attached claims.

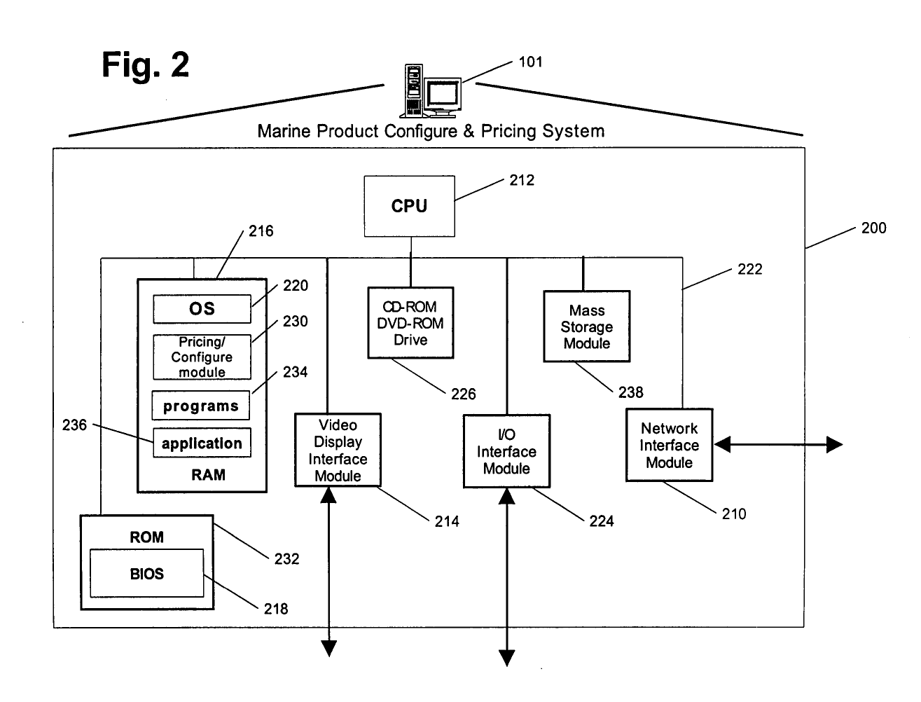

FIG. 2 illustrates a computing system that may be used to construct a marine product configuration and pricing system according to one possible embodiment of the present invention. In an exemplary embodiment of a marine product configuration and pricing processing system 200, computing system 200 is operative to provide a cardiac analysis processing system. Those of ordinary skill in the art will appreciate that marine product configuration and pricing processing system 200 may include many more components than those shown with reference to a computing system 200 shown in FIG. 2. However, the components shown are sufficient to disclose an illustrative embodiment for practicing the present invention. The marine product configuration and pricing processing system 200 is connected to other devices as needed. Those of ordinary skill in the art will appreciate that a network interface unit 210 includes the necessary circuitry for connecting cardiac analysis processing system to a network of other computing systems, and is constructed for use with various communication protocols including the TCP/IP protocol. Typically, network interface unit 210 is a card contained within neural network training and data collection system.

The marine product configuration and pricing processing system 200 also includes processing unit 212, video display adapter 214, and a mass memory 216, all connected via bus 222. The mass memory generally includes RAM 216, ROM 232, and one or more permanent mass storage devices, such as hard disk drive 238, a tape drive, CD-ROM/DVD-ROM drive 226, and/or a floppy disk drive. The mass memory stores operating system 220 for controlling the operation of a marine product configuration and pricing processing system 200. It will be appreciated that this component may comprise a general purpose server operating system as is known to those of ordinary skill in the art, such as UNIX, MAC OS™, LINUX™, or Microsoft WINDOWS NT®. Basic input/output system (“BIOS”) 218 is also provided for controlling the low-level operation of processing system 200.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing a software development and neural network analysis and training system. More specifically, the mass memory stores applications including product configuration and pricing program 230, other programs 234, and similar analysis tool applications 236. The product configuration and pricing program 230 includes computer executable instructions which, when executed by computer 200 to perform the logic described herein.

The marine product configuration and pricing processing system 200 also comprises input/output interface 224 for communicating with external devices, such as a mouse, keyboard, scanner, or other input devices not shown in FIG. 2. Likewise, marine product configuration and pricing processing system 200 may further comprise additional mass storage facilities such as CD-ROM/DVD-ROM drive 226 and hard disk drive 228. Hard disk drive 228 is utilized by marine product configuration and pricing processing system 200 to store, among other things, application programs, databases, and program data used by product configuration and pricing processing system application program 230. The operation and implementation of these databases is well known to those skilled in the art.

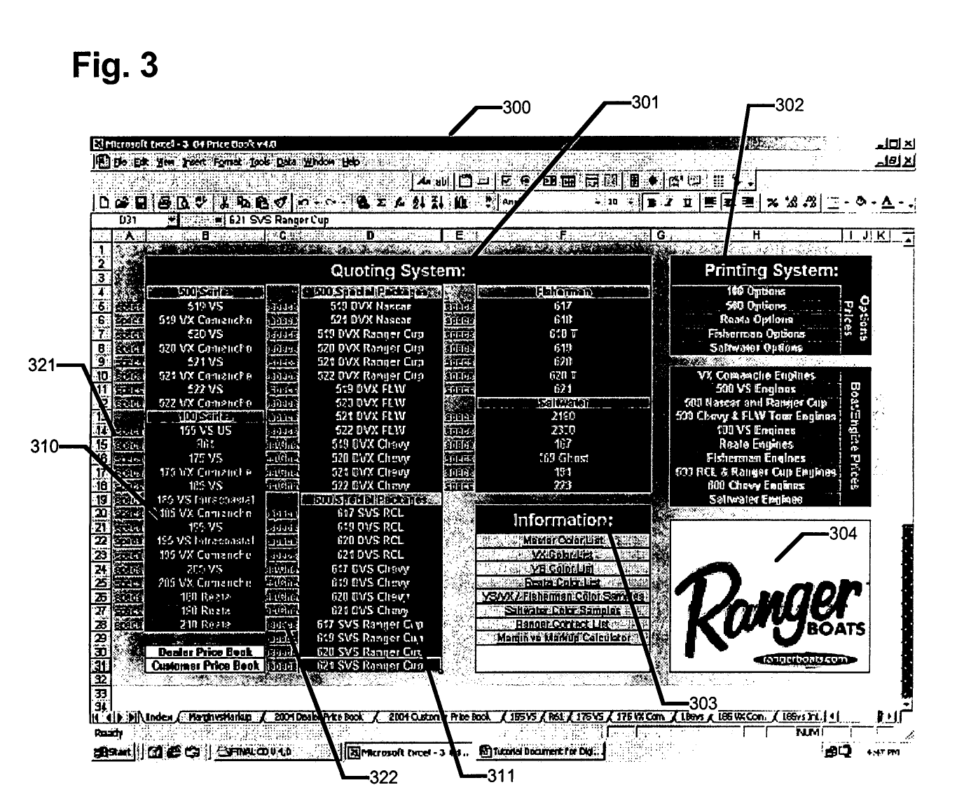

FIG. 3 illustrates an index screen from a marine product configuration and pricing system for a plurality of boat and supported options according to one possible embodiment of the present invention. The marine product configuration and pricing system 101 includes an index screen 300 that allows a sales person or customer to select the particular product that is to be configured and priced. The index screen 300 includes a quoting system section 301, a printing system section 302, an information section 303 and a logo section 304 for the products being sold. The sales person interacts with one or more of these sections to reach additional screens and documents of information used in the product configuration, pricing, and sales process.

The quoting system section 301 provides a set of hyperlinks to a set of screens or pages that are associated with each of the base products being sold. These hyperlinks may be grouped into various groupings of similar base products. For example, within the example index page 300, a set of products 310, 311 is shown. This set 310 contains a plurality of marine products identified as the 100 series. Similarly, a set of products within a Special Packages series 311 may also be included within the quoting system 301. Presumably, every base product that may be the basis of a configured system will be presented within the quoting system 301.

When a user selects a particular hyperlink, a new screen or page will be displayed that corresponds to the configuration and pricing for the particular product identified in the particular hyperlink. Within the quoting system 301, a set of additional hyperlinks is provided 321, 322 that present specification information for the each of the particular products listed in the quoting system 301. This specification information may be presented in a page or information or separate document, such as a PDF document saved within a format for a Portable Document Format as defined by Adobe Systems, Inc.

The printing system section 302 provides a sales person with a page that contains marked up selections of the price book containing configured products. Each item listed in the printing system section 302 corresponds to a particular selection of options that may be configured and priced for inclusion within a configured product. Hyperlinks are use within the printing system section 302 to navigate a user from the index page 301 to any of the desired pages.

The information section 303 contains hyperlinks to additional information pages that may be used when configuring and pricing a custom product. Finally, the logo section 304 provides a mechanism for provide a logo, trademark, or similar graphical and textual data that may indicate to the customer the manufacture or brand of products being sold. While the examples being presented herein describe the configuration and pricing of marine products, one skilled in the art will recognize that the present invention may also be used to configure a price for other products that are based upon a base product and a set of optional items that is configured by the end seller that offers the custom configured product to customers.

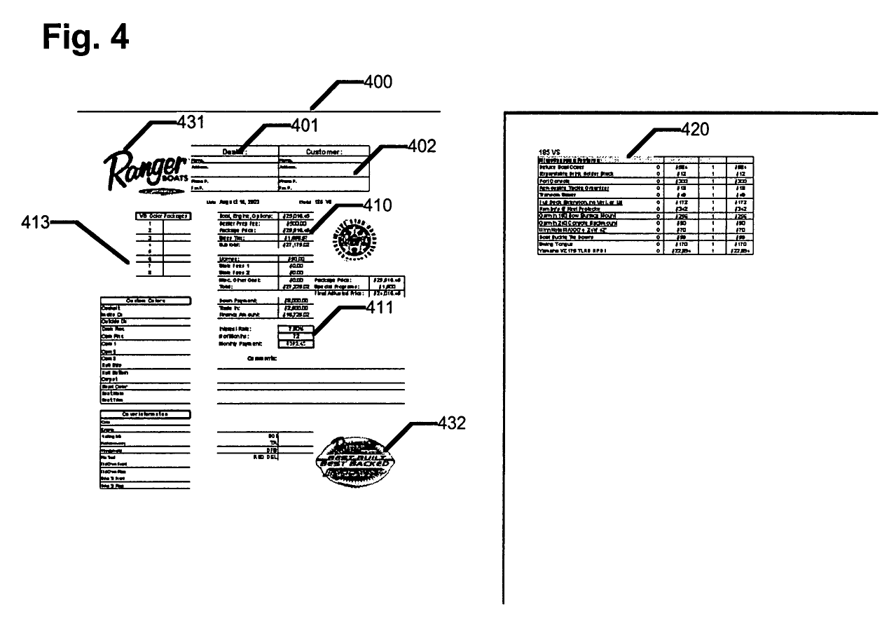

FIG. 4 illustrates an example price quote constructed using a marine product configuration and pricing system according to one possible embodiment of the present invention. The example price quote 400 includes a plurality of pages used to illustrate a price for a configured product. The example quote 400 is presented in a particular format; however one skilled in the art will recognize that any number of document formats for the layout of the quote pages is possible.

The example price quote 400 contains information that describes the product being configured and all of the optional items and additional optional items included within the custom product. In this particular example quote 400, the document includes dealer 401 and customer 402 information, including name, address and telephone numbers. The example price quote 400 also includes sets of price information 410 that may include financing price information 411 if appropriate. The example price quote 400 may include sections for the selection of options associated with the base product being configured 413 as well as a listing of the optional items being included in the custom configured product 420. As discussed above, graphical items, logos, and trademarks 431-432 may be included within the example price quote document to customize the price document with items to identify the brand of the product being purchased and/or the dealer offering the product to the customer.

All of the information within this example price quote page 400 is obtained from the other pages within the marine product configuration and pricing system 101 as the custom product is being configured and priced. Once the sales person completes the configuration and pricing operations, the documentation associated with the price quote is generated. In the example embodiment, the marine product configuration and pricing system is constructed as a set of EXCEL™ spreadsheets tabs from MICROSOFT CORPORATION. One skilled in the art will recognize that alternate programming mechanisms may be utilized to present similar screens of user interface images and data without deviating from the present invention as recited within the attached claims.

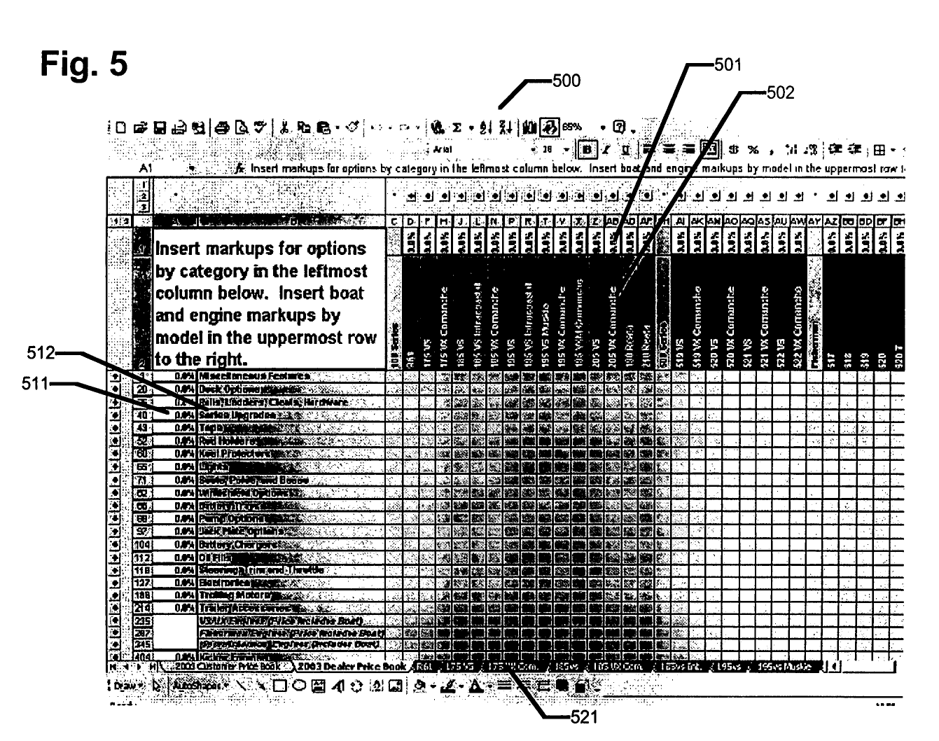

FIG. 5 illustrates an example markup page in a marine product configuration and pricing system having variable price markups for options according to one possible embodiment of the present invention. The example markup page 500 provides a mechanism for a sales person to specify the customer price for a product and its optional equipment. In this page, the sales person specifies the amount of markup or margin that is to be included in the customer price based upon a particular dealer price for that product and its optional equipment. A particular markup page permits a sales person to specify the percentage to be used for either a markup value or a margin value when a customer price is calculated. These two values are different mechanisms to define the amount for a customer price based upon a dealer price.

To understand the difference between a markup value and a margin value, consider an example option item having a dealer cost of $100. A markup value of 18% results in a customer price of $118.00. This markup figure results from a calculation:
(Dealer Price)×(1+markup value/100) or
($100)×(1+0.18)=$118.00.

In contrast, consider the same item having a dealer cost of $100 and a margin of 18%. A price increase having an 18% margin requires a customer price of $121.95. This margin figure results from a calculation:
(Dealer Price)/(1−(margin value/100)) or
($100)/(1−0.18)=($100)/0.82=$121.95.

Either a markup value or a margin value may be used in the marine product configuration and pricing system. A sales person merely needs to realize which pricing formula is being used. Of course, other mechanisms for specifying the customer price based upon the dealer price may be used here without deviating from the spirit and scope of the present invention as recited within the attached claims.

With the above understanding, the markup page is disclosed. In the markup page 500, a page is shown for each product that is available for configuration and pricing within the system 101. These pages would correspond to the same products identified on the index page discussed above with reference to FIG. 3. For a given product, the user may specify the markup percentage 502 for a particular base product option 501, in this case a boat and engine markup value. This percentage value is then automatically used when the system 101 determines a customer price when the product is being configured. Similarly, the markup percentages 511 for optional equipment 512 may be used when configuring a particular product. A separate page for each base product is selected using 521 selection tabs on this markup page 500.

In this example, a particular markup value is shown for a single base product 511 or optional item 512. In alternate embodiments, a single markup value may be used for all items of equipment of a particular type. For example, all electronic equipment may possess a markup value of 18% where all trailer accessories may possess a markup value of 16%. This arrangement is contrasted with an embodiment in which each item of electronics equipment and each item of trailer accessories possess an individual markup value. Because the groupings may be based on any set of criteria, groupings of items having a common markup value may also be based upon a type of equipment from a particular supplier. Thus a set of electronic items from reseller A may possess a markup value of 18% where a similar set of electronic items from reseller B may possess a markup value of 16%. The choice in defining what items are included within a particular grouping and what items may possess an individual markup value is a design choice that would be well understood by one of ordinary skill in the art to permit a sales person to define a price for a configured product in a manner consistent with the business practices of the dealer.

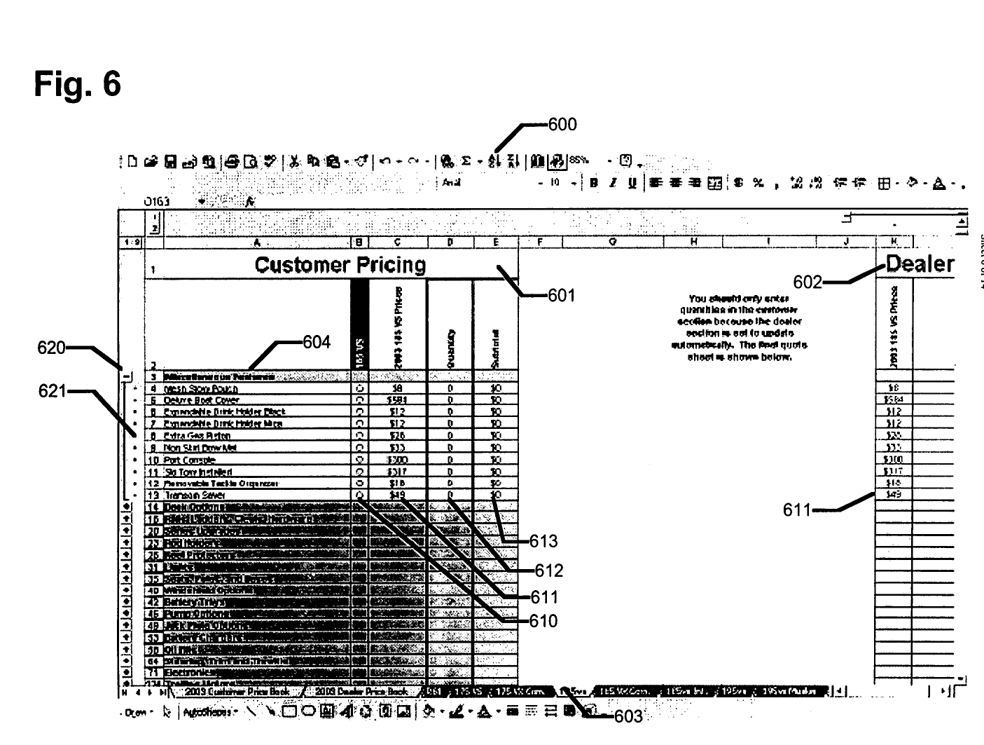

FIG. 6 illustrates an example pricing quote page for a marine product configuration and pricing system according to one possible embodiment of the present invention. The pricing quote page 600 may be selected 603 and utilized to specify the optional equipment that is to be included when a custom product is being configured. The pricing quote page includes a customer pricing section 601 as well as a dealer pricing section 602. Within the customer pricing area 601, a listing of items 604 is provided. These items 604 may be expanded from grouping of items 621 using an expand button 620 to display all of the items 621 in the grouping 620.

For each of the items listed in a particular grouping, a set of columns 610-613 is displayed. These columns include an item selection column 610, a customer price 611, a quantity 612, and a subtotal 613. The item selection column 610 contains a button for each item that indicates if the particular item is to be included within the configured product. A user configures a custom product by selecting a set of items that are desired to be included in the configured product using this set of buttons 610. The customer price column 611 includes the customer price for an item that may be selected. The customer price for an item in column 611 is automatically calculated using the margin values specified for the particular item as discussed above with respect to FIG. 5. The dealer price for the item is maintained within a database of prices elsewhere within the system 101.

A user enters the number of copies of a particular selected item that are to be included within the configured product in quantity column 612. The subtotal contains the subtotal price for each optional item by multiplying the price from column 611 with the quantity value in column 612. The subtotal column 613 may be summed once all of the desired optional items are selected to determine the price of the configured product.

Within the dealer area 602, the customer price for each optional item 611 is displayed. In alternate embodiments, the markup values and dealer prices may also be displayed to permit a sales person to determine if any additional discounts may be available to encourage a customer to complete a sale without depriving the dealer of a profit from the sale.

In alternate embodiments not shown in FIG. 6, additional processing logic may be included within the system 101 to permit configuration of only certain combinations of options. In this alternate embodiment, the selection of one option may either require the selection of a set of other options or disable the ability to select a second set of options. If any of the disabled options are already selected, an error message may be generated to the user to correct the selected set of options to include only a valid set of options. This processing logic may be included within a set of rules that are checked when items are selected. Implementations of such rule-based configuration systems are known in the art.

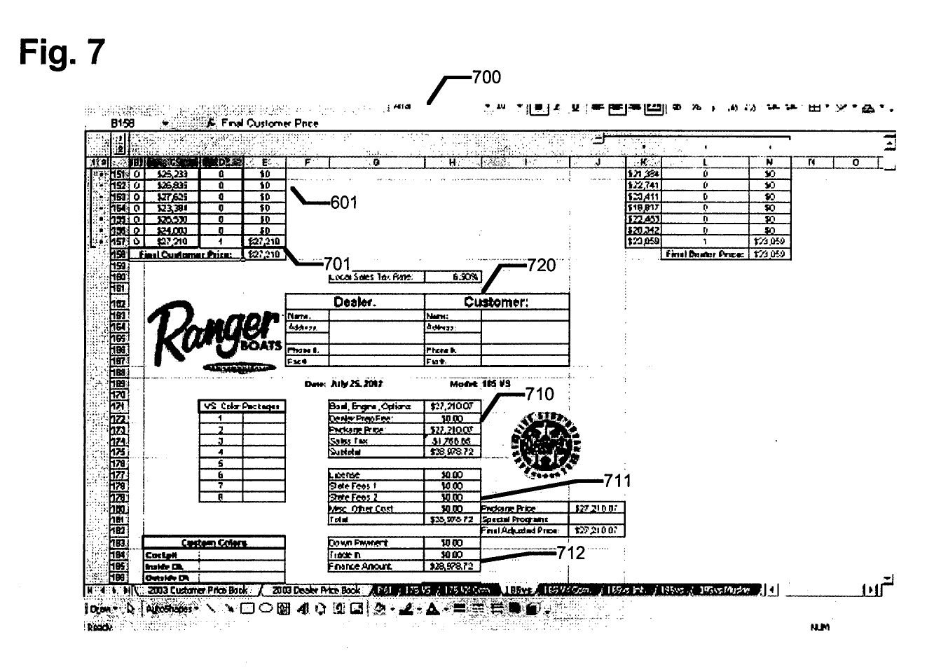

FIG. 7 illustrates another example of a pricing page from a marine product configuration and pricing system used to generate a price quote according to one possible embodiment of the present invention. The pricing page 700 contains the configured optional item pricing generated in the customer pricing area 601 as discussed above in FIG. 6. The total customer price 701 is automatically generated by totaling the prices for all of the included options. This pricing page includes customer and dealer address information 720 and the total price for the configured product 710-712. This total price includes the price paid to the dealer 710, any taxes and other fees 711 and the financing information 712 that will be part of the purchase of the configured product. All of this information corresponds to the information contained within the quote 400 discussed above with reference to FIG. 4. This information is generated by the system 101 as the product is configured to permit the automatic generation of the quote document 400.

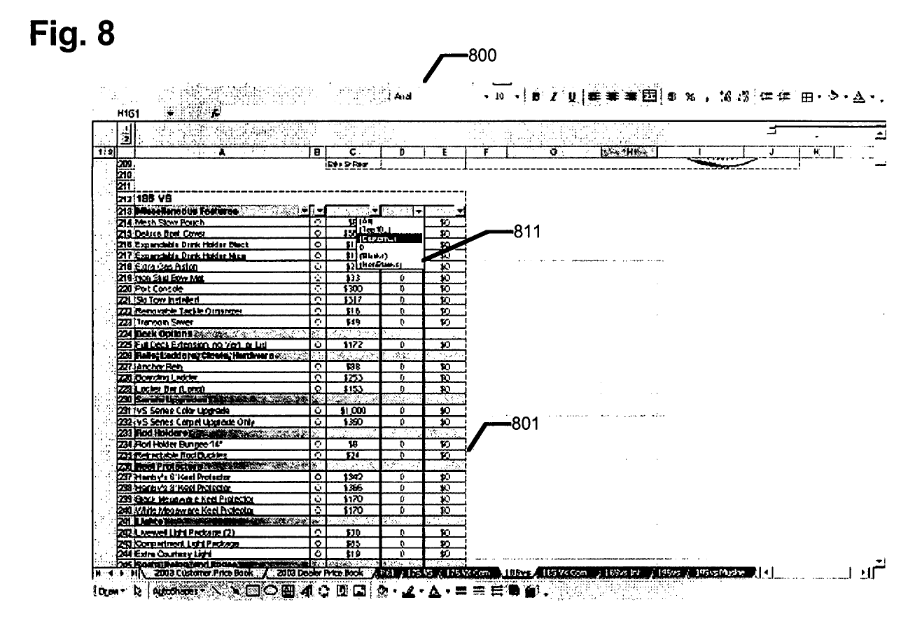

FIG. 8 illustrates an example a set of optional items from a configured product generated by a pricing and configuration input screen 800 for an example product according to one possible embodiment of the present invention. The set of optional items 801 includes a list of all of the optional items included within the configured product as the options are configured to be part of the configured product as discussed above. This list of optional items 801 may be included within the quote document shown in FIG. 4 to document which optional items are included within the configured product.

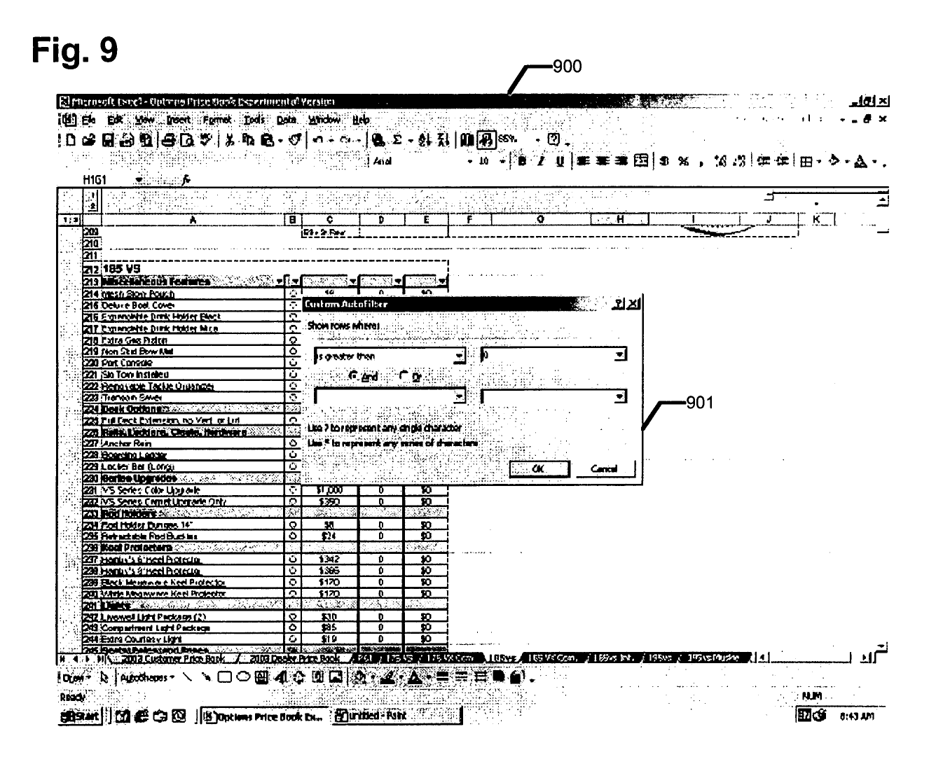

An option to display all of the available options or only the selected options may be set for viewing in the data 811. In displaying only the items selected, a control option 901 is displayed by a screen 900, as shown in FIG. 9, to set the list to display only items in the list that include a quantity greater than 1. This embodiment of the control is part of the implementation that utilizes EXCEL™ to display all or a subset of the items in a list. One of ordinary skill in the art will recognize that other embodiments may use other user control mechanisms to change the display characteristics of this list.

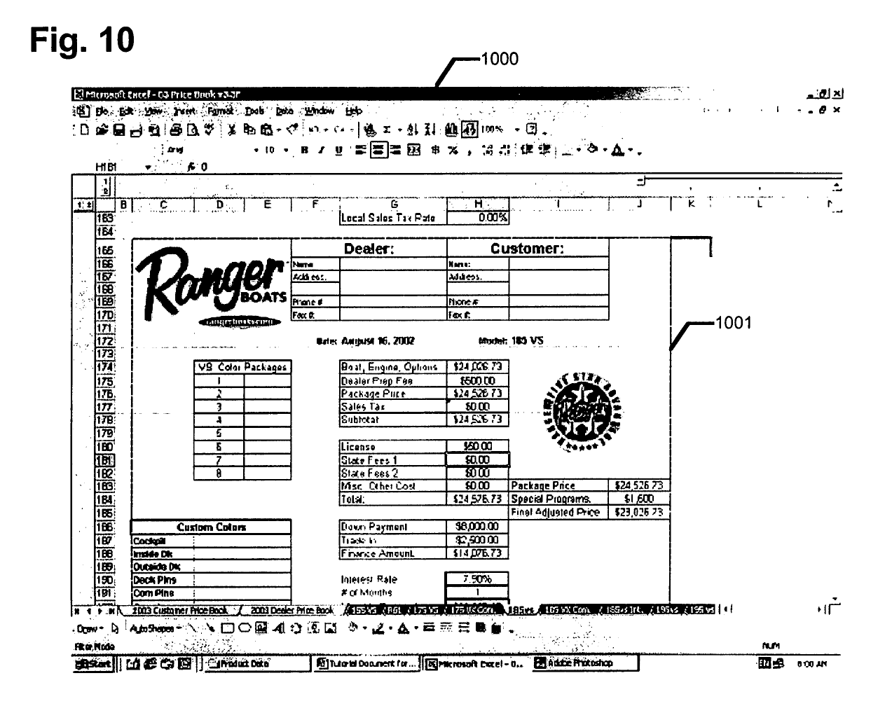

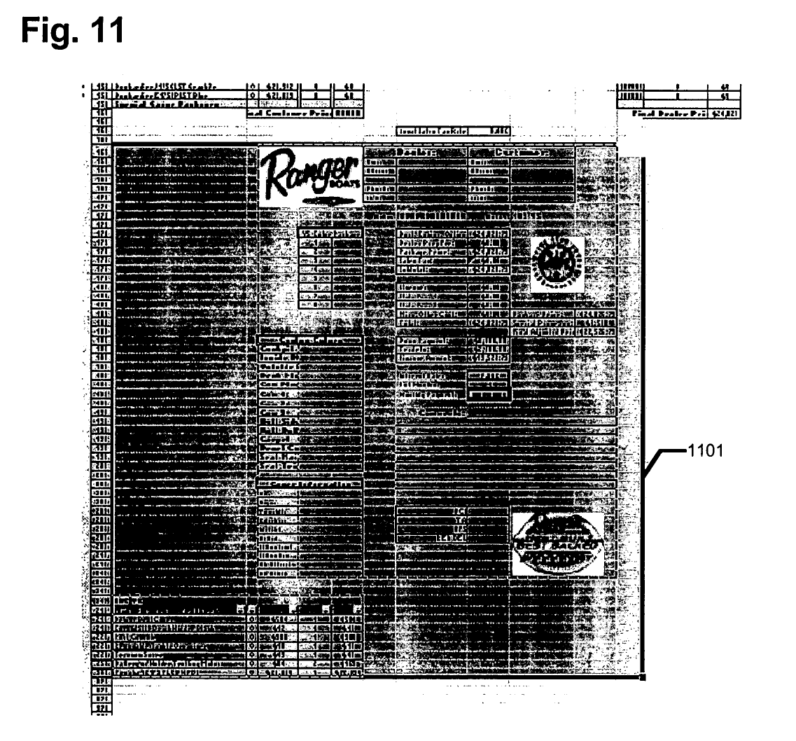

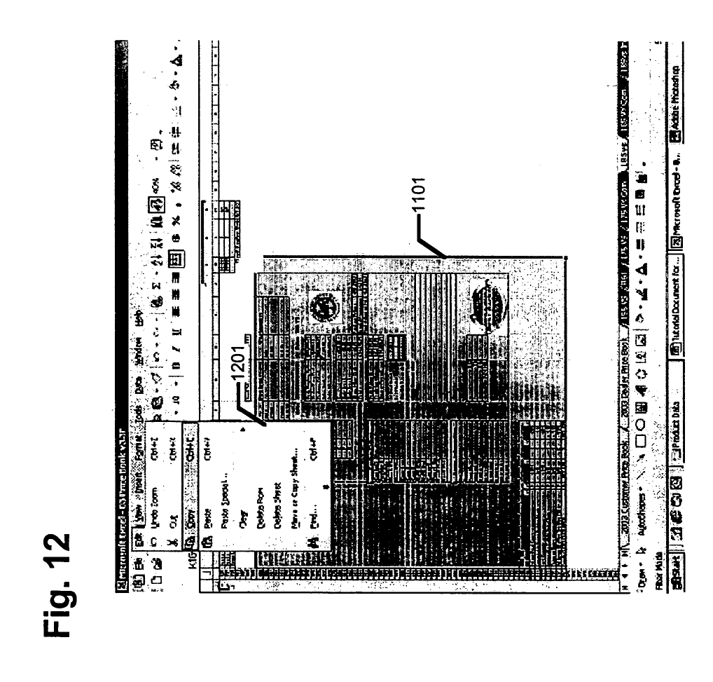

FIG. 10 illustrates an example screen 1000 for selection of a price quote of a custom configured product according to one possible embodiment of the present invention. Once all of the information for the configured product is generated 1001 as discussed above, the data may be moved to a quote sheet as shown in FIG. 4. for printing and display to a customer. FIG. 10 illustrates how a portion of the pricing page discussed above with respect to FIG. 7 is selected. Once the data is selected as shown on the display 1101 in FIG. 11, the data and its organization, may be copied to the quote sheet of FIG. 4. The copying operation 1201 is illustrated in FIG. 12. This embodiment of the copy operation for the quote data 1101 is part of the implementation that utilizes EXCEL™ as discussed above. One of ordinary skill in the art will recognize that other embodiments may use other user control mechanisms to copy the data and generate the quote sheet of FIG. 4 using the data shown in FIG. 7.

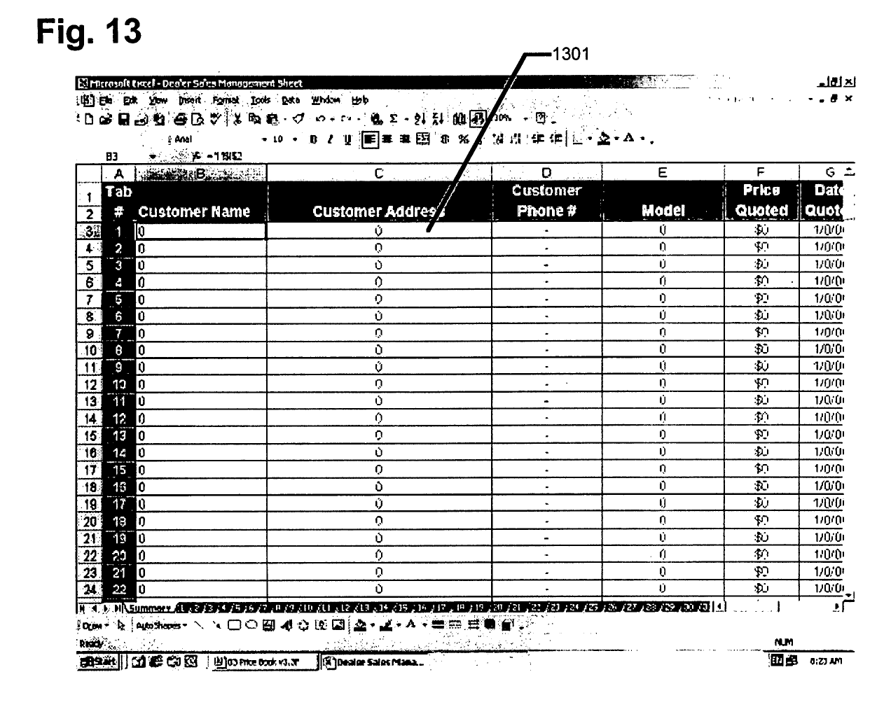

FIG. 13 illustrates an example customer list generated within a marine product configuration and pricing system according to one possible embodiment of the present invention. As quote sheets are generated, the customer address information may be automatically collected and stored into a saved list 1301 in the system 101 as part of the above configuration and pricing process. The customer address information may be included within a complete customer list, as shown in FIG. 13. This customer list may be used by a dealer to contact its customers at any time in the future as part of its sales and marketing activities. This list may be automatically generated to make the process of creating such a list easy since all of this information is already acquired and entered into the system as part of the above processing.

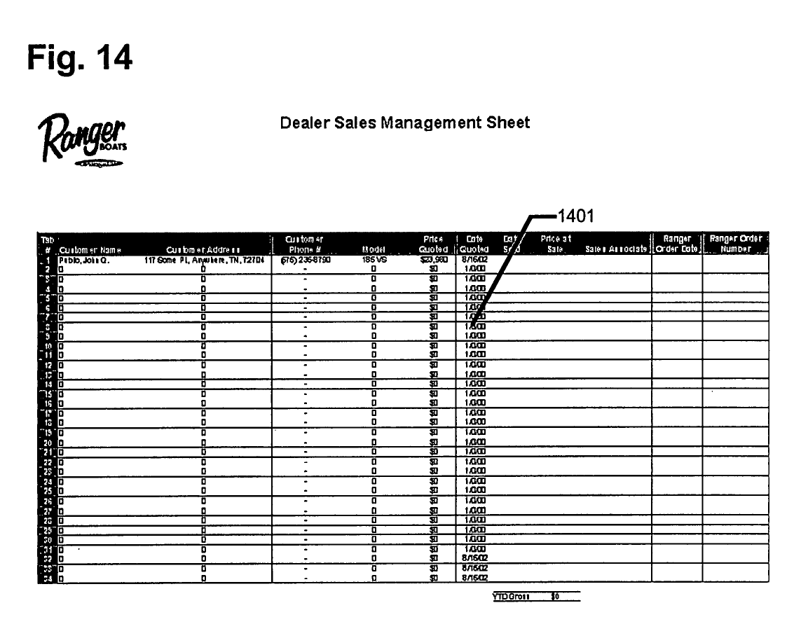

FIG. 14 illustrates an example dealer sales management sheet generated within a marine product configuration and pricing system according to one possible embodiment of the present invention. Similarly, a list of all generated quotes 1401 may be automatically generated as part of the generation of the individual quote sheets shown in FIG. 4. This list of generated quotes may include all of the information necessary to track the completion and delivery of a configured product as well as the accounting for all of the costs and fees paid as part of the sale of a configured product.

FIG. 2 illustrates an example of a suitable operating environment in which the invention may be implemented. The operating environment is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, held-held or laptop devices, multiprocessor systems, microprocessor-based systems, programmable consumer electronics, network PCs, minicomputers, mainframe computers, distributed computing environments that include any of the above systems or devices, and the like.

The invention may also be described in the general context of computer-executable instructions, such as program modules, executed by one or more computers or other devices. Generally, program modules include routines, programs, objects, components, data structures, etc. that perform particular tasks or implement particular abstract data types. Typically the functionality of the program modules may be combined or distributed in desired in various embodiments.

A processing devices attached to a communications network typically includes at least some form of computer readable media. Computer readable media can be any available media that can be accessed by these devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by processing devices.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

Additionally, the embodiments described herein are implemented as logical operations performed by programmable processing devices. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

While the above embodiments of the present invention describe a method, apparatus, and article of manufacture for providing a marine product configuration and pricing system, one skilled in the art will recognize that the use of a particular computing architecture for a data processing system are merely example embodiments of the present invention. It is to be understood that other embodiments may be utilized and operational changes may be made without departing from the scope of the present invention as recited in the attached claims.

As such, the foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. The present invention is presently embodied a method, apparatus, and article of manufacture for providing a marine product configuration and pricing system.

1. A system for providing a marine product configuration and pricing system, the system comprising:
an index product module for displaying all of the available products that may be configured;
a markup module for specifying the amount a dealer price may be increased for a product and optional item based upon a specified figure;
a price quoting generation module for selecting the product and optional items to be included within a configured product, the price quoting generation module generates a customer price for the product, selected optional items, and a total price for the configured product using the pricing data from the markup module; and
a quote sheet module for generating a quote sheet document containing information describing the configured product and its generated price.

2. The system according to claim 1, wherein the index product module includes a first hyperlink corresponding to every product that may be configured, the first hyperlink activates the price quoting generation module using configuration and pricing data corresponding to the selected product.

3. The system according to claim 2, wherein the index product module includes a second hyperlink corresponding to every product to be configured, the second hyperlink presents specification data corresponding to a particular product.

4. The system according to claim 3, wherein the specification data is displayed within an HTML document.

5. The system according to claim 3, wherein the specification data is displayed within a PDF document.

6. The system according to claim 1, wherein the price quoting generation module utilizes a markup percentage value to specify the amount a dealer price is to be increased when generating a customer price.

7. The system according to claim 1, wherein the price quoting generation module utilizes a margin percentage value to specify the amount a dealer price is to be increased when generating a customer price.

8. The system according to claim 1, wherein the quote sheet module generates the quote sheet document containing only customer pricing.

9. The system according to claim 1, wherein the quote sheet module generates the quote sheet document containing only dealer pricing.

10. The system according to claim 1, wherein the quote sheet module generates the quote sheet document containing both dealer pricing and customer pricing.

11. The system according to claim 9, wherein the quote sheet module further generates an optional item order sheet document for each optional item included within the configured product.

12. A method for providing a marine product configuration and pricing system, the method comprising:
selecting a configurable product from a group of available products;
selecting one or more optional items from a group of available optional items corresponding to the selected configurable product;
generating a dealer cost for the selected configurable product and the selected one or more optional items from a database of dealer costs;
generating a customer price for the selected configurable product and the selected one or more optional items using the dealer costs and a price increase value corresponding to the selected configurable product and to each of the selected one or more selected optional items; and
generating an individualized price quote document for the selected configurable product and the selected one or more optional items.

13. The method according to claim 12, wherein the price increase value corresponding to a group of the selected one or more selected optional items corresponds to a single group price increase value specified in a set of price increase values.

14. The method according to claim 13, wherein the price increase value is defined as a markup percentage value.

15. The method according to claim 12, wherein the price increase value is defined as a margin percentage value.

16. The method according to claim 12, wherein the method further comprises modifying the price increase value for at least one of the price increase value corresponding to one of the selected optional items to generate a modified individual price quote document.

17. The method according to claim 12, wherein the individualized price quote document includes the customer price.

18. The method according to claim 12, wherein the individualized price quote document includes the dealer costs.

19. The method according to claim 12, wherein the individualized price quote document includes both the customer price and the dealer costs.

20. The method according to claim 12, wherein the method further comprises generating a set of ordering documents, each order document in the set of ordering documents corresponds to each of the selected optional items.

21. A computer data product containing computer readable data encoding instructions for implementing a computer implemented method for providing a marine product configuration and pricing system, the method comprising:
selecting a configurable product from a group of available products;
selecting one or more optional items from a group of available optional items corresponding to the selected configurable product;
generating a dealer cost for the selected configurable product and the selected one or more optional items from a database of dealer costs;
generating a customer price for the selected configurable product and the selected one or more optional items using the dealer costs and a price increase value corresponding to the selected configurable product and to each of the selected one or more selected optional items; and
generating an individualized price quote document for the selected configurable product and the selected one or more optional items.

22. The computer data product according to claim 21, wherein the price increase value corresponding to a group of the selected one or more selected optional items corresponds to a single group price increase value specified in a set of price increase values.

23. The computer data product according to claim 22, wherein the price increase value is defined as a markup percentage value.

24. The computer data product according to claim 21, wherein the price increase value is defined as a margin percentage value.

25. The computer data product according to claim 21, wherein the method further comprises modifying the price increase value for at least one of the price increase value corresponding to one of the selected optional items to generate a modified individual price quote document.

26. The computer data product according to claim 21, wherein the individualized price quote document includes the customer price.

27. The computer data product according to claim 21, wherein the individualized price quote document includes the dealer costs.

28. The computer data product according to claim 21, wherein the individualized price quote document includes both the customer price and the dealer costs.

29. The computer data product according to claim 21, wherein the method further comprises generating a set of ordering documents, each order document in the set of ordering documents corresponds to each of the selected optional items.

30. The computer data product corresponds to a computer readable storage media.
